(19) United States
(12) Patent Application Publication
(10) Pub. No.: US 2016/0274429 A1
(43) Pub. Date: Sep. 22, 2016

(54) LIQUID CRYSTAL DISPLAY DEVICE

(71) Applicant: JVC KENWOOD Corporation, Yokohama-shi (JP)

(72) Inventor: Masato FURUYA, Yokohama-shi (JP)

(21) Appl. No.: 14/958,329

(22) Filed: Dec. 3, 2015

(30) Foreign Application Priority Data
Mar. 19, 2015 (JP) 2015-055793

(51) Int. Cl. G02F 1/1362; G02F 1/1368

(52) U.S. Cl. CPC G02F 1/136213; G02F 1/136277; G02F 1/1368; G02F 2001/13606

(57) ABSTRACT

A pixel portion has a liquid crystal sandwiched between a pixel electrode and a common electrode. Incident Light onto the liquid crystal is modulated in response to a potential difference between the pixel electrode and the common electrode. A drive portion includes: a first transistor that receives a pixel signal; a first holding capacitance portion that holds the pixel signal; a second transistor that transfers the pixel signal held in the first holding capacitance portion; and a second holding capacitance portion that holds the transferred pixel signal. The drive portion collectively transfers the pixel signals, which are held in all of the first holding capacitance portions of the plurality of pixel circuits, to all of the second holding capacitance portions, and drives the liquid crystals by applying, to the pixel electrodes, voltages corresponding to the pixel signals held in the second holding capacitance portions.

### CROSS REFERENCE TO RELATED APPLICATION

This application is based upon and claims the benefit of priority under 35U.S.C.§119 from Japanese Patent Application No. 2015-055793, filed on Mar. 19, 2015, the entire contents of which are incorporated herein by reference.

### BACKGROUND

The present disclosure relates to a reflection-type liquid crystal display device that adopts a structure of sandwiching a liquid crystal between a semiconductor substrate and a transparent substrate.

As a conventional technology of this type of liquid crystal display device, the liquid crystal display device which is described in Japanese Unexamined Patent Application Publication No. 2004-133147 (Patent Document 1) is known. Patent Document 1 describes a reflection-type liquid crystal display device including a plurality of pixel circuits arranged in a matrix fashion on a silicon substrate.

In each of the pixel circuits, a pixel signal is written and held inside a second capacitor through a second transistor, and the held pixel signal is transferred and held inside a first capacitor through a first transistor. The pixel signal held in the first capacitor is applied to a reflection electrode of a liquid crystal display element, and the liquid crystal element is driven.

### SUMMARY

In the above-described conventional liquid crystal display device, a parasitic capacitance is formed between one electrode terminal of the first capacitor that holds the pixel signal and one electrode terminal of the second capacitor that holds the pixel signal. In such a way, one electrode terminal in which the first capacitor holds the pixel signal and one electrode terminal in which the second capacitor holds the pixel signal are subjected to capacitive coupling by this parasitic capacitance.

When a capacitance value of this parasitic capacitance becomes such a value that cannot be ignored with respect to a capacitance value of the first capacitor, then there occurs a crosstalk of a voltage owing to the parasitic capacitance. That is, a voltage of the pixel signal held in the second capacitor causes the crosstalk to one electrode terminal of the first capacitor through the parasitic capacitance.

When the crosstalk occurs, a voltage of the pixel signal held in the first capacitor varies. When the voltage of the pixel signal varies, a contrast of an image displayed on the liquid crystal becomes non-uniform. That is, the conventional liquid crystal display device has a defect in that the contrast of the image displayed on the screen varies in the vertical direction.

A first aspect of the embodiments provides a liquid crystal display device including: a plurality of pixel circuits sandwiched between a semiconductor substrate and a transparent substrate and arranged in a matrix fashion, wherein the pixel circuits include: pixel portions, each having a liquid crystal sandwiched between a pixel electrode formed on the semiconductor substrate and a common electrode formed on the transparent substrate, in which the liquid crystal is driven in response to a potential difference between a voltage applied to the pixel electrode and a voltage applied to the common electrode, and incident light from the transparent substrate is modulated in the liquid crystal in response to the potential difference; drive portions, each having: a first transistor that is formed on the semiconductor substrate and selectively receives a pixel signal; a first holding capacitance portion that holds the pixel signal selectively received through the first transistor; a second transistor that is formed on the semiconductor substrate and transfers the pixel signal held in the first holding capacitance portion; and a second holding capacitance portion that holds the pixel signal transferred through the second transistor, the drive portions collectively transferring the pixel signals, which are held in all of the first holding capacitance portions of the plurality of pixel circuits, to all of the second holding capacitance portions of the plurality of pixel circuits, and driving the liquid crystals by applying, to the pixel electrodes, voltages corresponding to the pixel signals held in the second holding capacitance portions; and shield portions, each being disposed between a first electrode portion that composes one electrode of the first holding capacitance portion or a first wiring portion connected to the first electrode portion and a second electrode portion that composes one electrode of the second holding capacitance portion or a second wiring portion connected to the second electrode portion, wherein each of the shield portions is supplied with a predetermined shield potential that is preset.

A second aspect of the embodiments provides a liquid crystal display device including: a plurality of pixel circuits sandwiched between a semiconductor substrate and a transparent substrate and arranged in a matrix fashion, wherein the pixel circuits include: pixel portions, each having a liquid crystal sandwiched between a pixel electrode formed on the semiconductor substrate and a common electrode formed on the transparent substrate, in which the liquid crystal is driven in response to a potential difference between a voltage applied to the pixel electrode and a voltage applied to the common electrode, and incident light from the transparent substrate is modulated in the liquid crystal in response to the potential difference; drive portions, each having: a first transistor that is formed on the semiconductor substrate and selectively receives a pixel signal; a first holding capacitance portion that holds the pixel signal selectively received through the first transistor; a second transistor that is formed on the semiconductor substrate and transfers the pixel signal held in the first holding capacitance portion; and a second holding capacitance portion that holds the pixel signal transferred through the second transistor, the drive portions collectively transferring the pixel signals, which are held in all of the first holding capacitance portions of the plurality of pixel circuits, to all of the second holding capacitance portions of the plurality of pixel circuits, and driving the liquid crystals by applying, to the pixel electrodes, voltages corresponding to the pixel signals held in the second holding capacitance portions; and shield portions, each being disposed between a first electrode portion that composes one electrode of the first holding capacitance portion or a first wiring portion connected to the first electrode portion and a second electrode portion that composes one electrode of the second holding capacitance portion, wherein each of the shield portions is supplied with a predetermined shield potential that is preset.

### BRIEF DESCRIPTION OF THE DRAWINGS

FIG. 1 is a configuration diagram showing a liquid crystal display device according to the first embodiment.

FIG. 2 is a chart showing an example of a drive voltage and transmissivity characteristics of a liquid crystal.

FIG. 3 is a chart schematically showing a voltage applied to the liquid crystal and a drive mode of the liquid crystal.

FIG. 4 is a cross-sectional view showing a schematic cross-sectional structure of a pixel circuit in the liquid crystal display device according to the first embodiment.

FIG. 5 is a plan view showing a planar structure of second wiring layers of such pixel circuits.

FIG. 6 is a view showing the arrangement of representative pixels on a liquid crystal display screen of the liquid crystal display device according to the first embodiment.

FIG. 7 is a timing chart showing changes of a variety of signals of the liquid crystal display device according to the first embodiment.

FIG. 8 is a cross-sectional view showing a schematic cross-sectional structure of a pixel circuit in a liquid crystal display device according to a second embodiment.

### DETAILED DESCRIPTION

A description is made below of the respective embodiments by using the drawings.

### First Embodiment

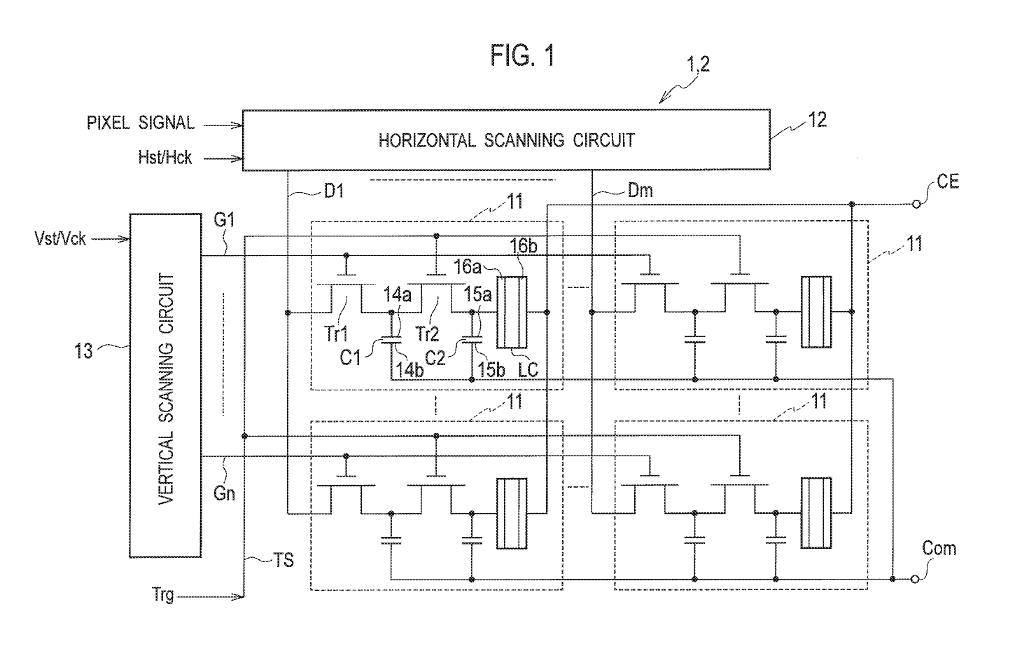

A description is made below of a circuit configuration of a liquid crystal display device according to the first embodiment with reference to FIG. 1. In FIG. 1, a liquid crystal display device 1 includes pixel circuits 11, a horizontal scanning circuit 12 and a vertical scanning circuit 13.

A plurality (m×n) of the pixel circuits 11 is arranged in a matrix fashion on respective crossing portions of m number of column data lines D (D1 to Dm) and n number of row scanning lines G (G1 to Gn). All of the pixel circuits 11 are configured in the same way. Hence, here, the pixel circuit 11 disposed on the crossing portion of the column data line D1 and the row scanning line G1 is taken as a representative, and a description is made of a configuration of the pixel circuit 11.

The pixel circuit 11 includes a first transistor Tr1, a second transistor Tr2, a first holding capacitance portion C1, a second holding capacitance portion C2, and a liquid crystal LC.

The first transistor Tr is a switching transistor, and is for example, composed of an N-channel MOS-type field-effect transistor. In the first transistor Tr1, a gate terminal is connected to the row scanning line G1, and a drain terminal is connected to the column data line D1. The first transistor Tr1 is subjected to a conduction control in response to a row selection signal given to the row scanning line G1, and selectively inputs a pixel signal, which is given to the column data line D1, to the pixel circuit 11.

The second transistor Tr2 is a transfer transistor, and is for example, composed of the N-channel MOS-type field-effect transistor. In the second transistor Tr2, a gate terminal is connected to a trigger signal line TS, and a drain terminal is connected to a source terminal of the first transistor Tr1.

The second transistor Tr2 is subjected to the conduction control in response to a trigger signal (Trg) given to the trigger signal line TS. The second transistor Tr2 transfers the pixel signal, which is held in the first holding capacitance portion C1, to the second holding capacitance portion C2.

The first holding capacitance portion C1 is composed of a so-called MIM (Metal-Insulator-Metal) structure in which a dielectric (not shown) is sandwiched between a first electrode portion 14a and a second electrode portion 14b, which are made of metal.

In the first holding capacitance portion C1, the first electrode portion 14a is connected to the source terminal of the first transistor Tr1 and to the drain terminal of the second transistor Tr2, and the second electrode portion 14b is connected to a reference potential common terminal Com.

The reference potential common terminal Com is given a preset reference potential Vcom, for example, a ground potential. The first holding capacitance portion C1 holds the pixel signal selectively inputted thereto through the first transistor Tr1.

The second holding capacitance portion C2 is composed of a MIM structure in which a dielectric (not shown) is sandwiched between a first electrode portion 15a and a second electrode portion 15b, which are made of metal.

In the second holding capacitance portion C2, the first electrode portion 15a is connected to the source terminal of the second transistor Tr2, and the second electrode portion 15b is connected to the reference potential common terminal Com.

The second holding capacitance portion C2 holds the pixel signal transferred from the first holding capacitance portion C1 through the second transistor Tr2.

The liquid crystal LC is composed by being filled and sealed between a pixel electrode 16a having light reflectivity and a common electrode 16b disposed opposite to the pixel electrode 16a while being spaced apart.

The pixel electrode 16a is connected to the source terminal of the second transistor Tr2 and the first electrode portion 15a of the second holding capacitance portion C2. The common electrode 16b is connected to a common electrode terminal CE. The common electrode terminal CE is given a common electrode voltage Vce preset in response to a voltage of the pixel signal given to the pixel electrode 16a.

The liquid crystal LC is driven in response to a potential difference between the voltage of the pixel signal given to the pixel electrode 16a and the common electrode voltage Vce given to the common electrode 16b.

The column data lines D (D1 to Dm) are connected to the horizontal scanning circuit 12. A horizontal synchronization signal (Hst), clock signals (Hck) for horizontal scanning, and pixel signals are inputted to the horizontal scanning circuit 12. Based on the horizontal synchronization signal and the clock signals for the horizontal scanning, the horizontal scanning circuit 12 sequentially outputs the pixel signals to the column data lines D1 to Dm in a unit of one horizontal scanning period.

The row scanning lines G1 to Gn are connected to the vertical scanning circuit 13. A vertical synchronization signal (Vst) and clock signals (Vck) for vertical scanning are inputted to the vertical scanning circuit 13. For example, based on the vertical synchronizing signal and the vertical scanning clock signals for vertical scanning, the vertical scanning circuit 13 sequentially supplies the row selection signals from the row scanning line G1 to the row scanning line Gn in a unit of one vertical scanning period.

As mentioned above, the pixel circuit 11 includes: a pixel portion including the liquid crystal LC sandwiched between the pixel electrode 16a and the common electrode 16b; and a drive portion including the first transistor Tr1, the second transistor Tr2, the first holding capacitance portion C1 and the second holding capacitance portion C2.

Next follows a description of operations of the liquid crystal display device 1 with the above-described configuration.

During one horizontal scanning period, the respective pixel signals corresponding to the respective column data lines D1 to Dm are outputted from the horizontal scanning circuit 12 to the respective column data lines D1 to Dm. Meanwhile, the selection signal, which turns the first transistors Tr1 to the conducting state, is outputted from the vertical scanning circuit 13 to each row scanning line G, for example, the row scanning line G1 during one horizontal scanning period. In such a way, m pieces of the first transistors Tr1 in which the gate terminals are connected to the row scanning line G1 turn to the conducting state.

The respective pixel signals outputted to the respective column data lines D1 to Dm are given and written into the first holding capacitance portions C1 through the first transistors Tr1 connected so as to correspond to the respective column data lines D1 to Dm. Thereafter, the selection signal, which turns the first transistors Tr1 to the non-conducting state, is outputted from the vertical scanning circuit 13 to the row scanning line G1. In such a way, the m pieces of first transistors Tr1 in which the gate terminals are connected to the row scanning line G1 turn to the non-conducting state.

The pixel signals written into the first holding capacitance portions C1 are held in the first holding capacitance portions C1 during a non-selection period until new pixel signals are given during a next vertical scanning period. Note that the second transistors Tr2 are in the non-conducting state until an operation, where the pixel signals are written and held in the first holding capacitance portions C1 of all of the pixel circuits 11, is ended.

Such a writing operation of the pixel signal is executed for all of the row scanning lines G, and the pixel signals equivalent to one frame are sequentially written and held in the first holding capacitance portions C1 of all of the m×n pieces of the pixel circuits 11.

When the writing operation of the pixel signals equivalent to one frame is ended, trigger signals which turn the second transistors Tr2 to the conducting state are commonly given all at once to the gate terminals of the second transistors Tr2 of all of the pixel circuits 11.

In such a way, the second transistors Tr2 of all of the pixel circuits 11 turn to the conducting state simultaneously. In all of the pixel circuits 11, the pixel signals held in the first holding capacitance portions C1 are transferred to the second holding capacitance portions C2 through the second transistors Tr2 all at once, and in addition, are applied as voltages which correspond to the pixel signals, to the pixel electrodes 16a. The pixel signals transferred to the second holding capacitance portion C2 are held in the second holding capacitance portion C2.

After the voltages corresponding to the pixel signals are applied to the respective pixel electrodes 16a of all of the pixel circuits 11, trigger signals which turn the second transistors Tr2 to the non-conducting state are given to the gate terminals of the second transistors Tr2, and the second transistors Tr2 turn to the non-conducting state. Thereafter, in such a way as mentioned above, a writing operation of the pixel signals of the next frame is started.

During a period while the writing operation of the pixel signals of the next frame is being performed, the second transistor Tr2 maintains the non-conducting state. In such a way, the pixel signals transferred to the second holding capacitance portions C2 are held in the second holding capacitance portions C2, and in addition, maintain a state of being applied as voltages, which correspond to the pixel signals, to the pixel electrodes 16a.

With regard to the pixel signals held in the second holding capacitance portions C2, pixel signal voltages are applied to the pixel electrodes 16a. The liquid crystals LC are driven in response to potential differences between the voltages of the pixel signals, which are applied to the pixel electrodes 16a, and the common electrode voltage Vice applied to the common electrode 16b, and display corresponding to the pixel signals written into the respective pixel circuits 11 is performed.

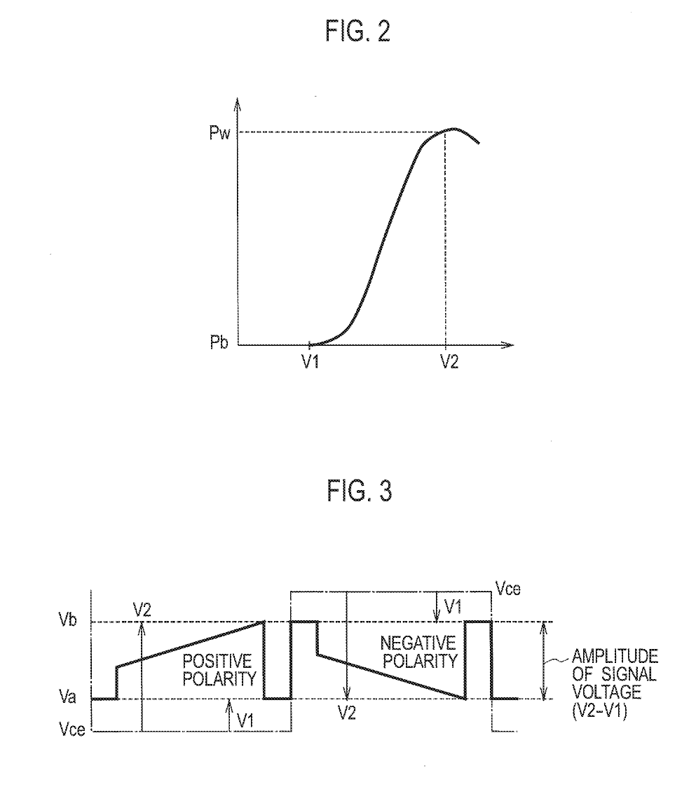

As a liquid crystal mode suitable for the reflection-type liquid crystal display device, there is an electrically controlled birefringence mode. In the electrically controlled birefringence mode, characteristics of a normally black type or a normally white type can be obtained by dielectric anisotropy and initial orientation of the liquid crystal. In the first embodiment, the normally black type is described with reference to FIG. 2.

FIG. 2 is a chart showing an example of a relationship between a liquid crystal drive voltage and transmissivity characteristics in each liquid crystal LC for use in the first embodiment. In FIG. 2, an axis of abscissas represents a voltage applied to the pixel electrode 16a of the liquid crystal LC, an axis of ordinates represents a monochrome display color of the display image, a voltage V1 corresponds to a black color (output light intensity Pb) of the display image, and a voltage V2 corresponds to a white color (output light intensity Pw) of the display image.

In the liquid crystal display device 1, from a viewpoint of preventing persistence of the display image and deterioration of a liquid crystal material, usually, it is preferable that the liquid crystal be driven by an alternating current voltage in which application of a voltage with a positive polarity and application of a voltage with a negative polarity are set alternately. Here, the positive polarity refers to a case where the voltage applied to the pixel electrode 16a is higher than the common electrode voltage Vce, and the negative polarity refers to a case where the voltage applied to the pixel electrode 16a is lower than the common electrode voltage Vce.

In accordance with a pixel circuit having such a configuration of capturing and holding the pixel signal through one transistor into one holding capacitance portion, the pixel signals cannot be supplied simultaneously to the liquid crystals of all of the pixel circuits.

In such a way, at a time of displaying black without changing the common electrode voltage Vce applied to the common electrode 16b of the liquid crystal LC, a voltage equal to a sum (Vce+V1) of the common electrode voltage Vce and the voltage V1 and a voltage equal to a difference (Vce−V1) of the common electrode voltage Vce from the voltage V1 are alternately applied to the pixel electrode 16a.

Meanwhile, at a time of displaying white, a voltage equal to a sum (Vce+V2) of the common electrode voltage Vce and the voltage V2 and a voltage equal to a difference (Vce−V2) of a difference of the common electrode voltage Vce from the voltage V2 are alternately applied to the pixel electrode 16a. Here, the voltage V1 and V2 are voltages shown in FIG. 2. In such a drive mode, an amplitude of the voltage applied to the pixel electrode 16a of the liquid crystal LC becomes 2×V2 at most.

In contrast, in the first embodiment, the liquid crystal display device 1 drives the liquid crystal LC by applying the voltage thereto in such a manner as shown in FIG. 3. FIG. 3 is a chart schematically showing the voltage applied to the liquid crystal LC for use in the first embodiment and the drive mode of the liquid crystal LC.

As shown in FIG. 3, the voltage Va applied to the pixel electrode 16a in an event of performing the black display with the positive polarity and the voltage Va applied to the pixel electrode 16a in an event of performing the white display with the negative polarity are approximately at same levels. Moreover, a voltage Vb applied to the pixel electrode 16a in an event of performing the white display with the positive polarity and a voltage Vb applied to the pixel electrode 16a in an event of performing the black display with the negative polarity are approximately the same level. As described above, the pixel electrode 16a is supplied with a voltage with a form in which voltage ranges and levels of the respective positive and negative polarities are the same.

In the event of displaying black at the positive polarity, the common electrode 16b is applied with the common electrode voltage Vce as a voltage lower by the voltage V1 than the voltage Va applied to the pixel electrode 16a. Moreover, in the event of displaying black at the negative polarity, the common electrode 16b is applied with the common electrode voltage Vce as a voltage higher by the voltage V1 than the voltage Vb applied to the pixel electrode 16a. That is, the common electrode voltage Vce becomes the difference (Va−V1) of the voltage Va from the voltage V1 at the positive polarity, and becomes the sum (Vb+V1) of the voltage Vb and the voltage V1 at the negative polarity.

Meanwhile, in the event of displaying white at the positive polarity, the common electrode 16b is applied with the common electrode voltage Vce as a voltage lower by the voltage V2 than the voltage Vb applied to the pixel electrode 16a. Moreover, in the event of displaying white at the negative polarity, the common electrode 16b is applied with the common electrode voltage Vce as a voltage lower by the voltage V2 than the voltage Va applied to the pixel electrode 16a. That is, the common electrode voltage Vce becomes the difference (Va−V2) of the voltage Vb from the voltage V2 at the positive polarity, and becomes the sum (Va+V2) of the voltage Va and the voltage V2 at the negative polarity.

As described above, in the case of performing the black display or the white display at the positive and negative polarities, then as shown in FIG. 3, the amplitude of the voltage applied to the pixel electrode 16a becomes a difference (Va−Vb) of the voltage Va from the voltage Vb, that is, a difference (V2−V1) of the voltage V2 from the voltage V1.

In such a way, with regard to such a voltage that should be applied to the pixel electrode 16a, it becomes possible to reduce the amplitude thereof in comparison with that in the case of not changing the common electrode voltage Vce. As a result, it becomes possible for the liquid crystal display device 1 to reduce required withstanding voltages of the first transistor Tr1, the second transistor Tr2, the first holding capacitance portion C1 and the second holding capacitance portion C2, and the density increase of the element can be realized.

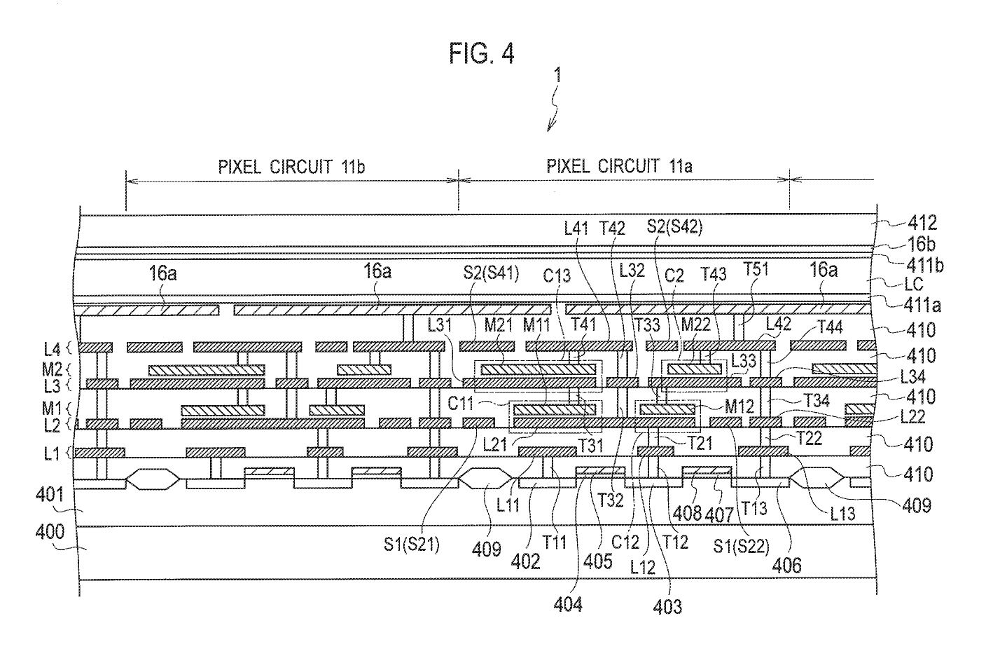

FIG. 4 is a cross-sectional view showing a schematic cross-sectional structure of the pixel circuit 11 in the liquid crystal display device 1 according to the first embodiment. FIG. 4 illustrates a cross-sectional structure of two pixel circuits 11a and 11b in a transverse direction of the sheet surface thereof, and all of the pixel circuits have a similar structure, and accordingly, the pixel circuit 11a shown in FIG. 4 is taken as a representative, and the structure of the pixel circuit 11 is described.

As will be described below, a large number of the pixel circuits 11 are arranged in a matrix fashion on a semiconductor substrate, and accordingly, as a pixel circuit adjacent to the pixel circuit 11a, the pixel circuit 11b shown in FIG. 4 is referred to while being taken as a representative.

In FIG. 4, for example, on such a semiconductor substrate 400 made of a silicon substrate, a well region 401 is formed. In the well region 401, the first transistor Tr1 and the second transistor Tr2, which are shown in FIG. 1, are formed. In a case where the first transistor Tr1 and the second transistor Tr2 are composed of N-channel field-effect transistors, the well region 401 becomes a P-type well region.

In the well region 401, diffusion layers 402 and 403, in which impurities are diffused, are formed while being spaced apart from each other by a predetermined distance. In the case where the first transistor Tr1 is composed of the N-channel field-effect transistor, N-type impurities, for example, such as boron, are implanted and diffused in the diffusion layers 402 and 403.

On the well region 401 between the diffusion layer 402 and the diffusion layer 403, polysilicon 405 is formed through a silicon oxide film 404 that becomes a gate oxide film. In such a way, the first transistor Tr1 is formed so that the diffusion layer 402 is a drain region, the diffusion layer 403 can be a source region, and the polysilicon 405 is a gate electrode.

Moreover, in the well region 401, a diffusion layer 406 in which impurities are diffused is formed, while being spaced apart from the diffusion layer 403 by a predetermined distance. In the case where the second transistor Tr2 is composed of the N-channel field-effect transistor, N-type impurities, for example, such as boron, are implanted and diffused in the diffusion layer 406.

On the well region 401 between the diffusion layer 403 and the diffusion layer 406, polysilicon 408 is formed through a silicon oxide film 407 that becomes a gate oxide film. In such a way, the second transistor Tr2 is formed so that the diffusion layer 403 is a drain region, the diffusion layer 406 can be a source region, and the polysilicon 408 is a gate electrode.

The diffusion layer 403 that becomes the source region of the first transistor Tr1 and the drain region of the second transistor Tr2 are made common to both of the transistors. In such a way, the source of the first transistor Tr1 and the drain of the second transistor Tr2 are electrically connected to each other.

While being adjacent to the diffusion layer 402 and the diffusion layer 406, an element isolation region 409 is formed so as to surround peripheries of the first transistor Tr1 and the second transistor Tr2. That is, the inside of the element isolation region 409 becomes the forming region of the first transistor Tr1 and the second transistor Tr2.

By this element isolation region 409, the first transistor Tr1 and the second transistor Tr2 are electrically isolated from a first transistor Tr1 and second transistor Tr2 of another pixel circuit adjacent thereto.

A multilayer wiring structure is formed in the region above the region where the first transistor Tr1 and the second transistor Tr2 are formed.

By this multilayer wiring structure, the first holding capacitance portion C1 and second holding capacitance portion C2 of one pixel circuit 11 are formed. That is, above the region where both of the transistors are formed, the first holding capacitance portion C1 and second holding capacitance portion C2 of one pixel circuit are formed in the area approximately equal to the forming area where both of the transistors are formed.

In this multilayer wiring structure, a first wiring layer L1, a second wiring layer L2, a third wiring layer L3 and a fourth wiring layer L4 are formed in order from the semiconductor substrate 400 toward an upper side. The first wiring layer L1 to fourth wiring layer L4 are composed of metal, for example, such as aluminum or copper. Respective wiring layers, which are the first wiring layer L1 to the fourth wiring layer L4, are insulated from one another by such interlayer insulating films 410, for example, such as silicon oxide films.

The first wiring layer L1 includes a first wiring portion L11, a second wiring portion L12 and a third wiring portion L13. The first wiring portion L11, the second wiring portion L12 and the third wiring portion L13 are electrically isolated from one another.

The first wiring portion L11 of the first wiring layer L1 is bonded to the diffusion layer 402, which becomes the drain region of the first transistor Tr1, through a through hole T11. The second wiring portion L12 of the first wiring layer L1 is bonded to the diffusion layer 403, which becomes the source region of the first transistor Tr1 and the drain region of the second transistor Tr2, through a through hole T12. The third wiring portion L13 of the first wiring layer L1 is bonded to the diffusion layer 406, which becomes the source region of the second transistor Tr2, through a through hole T13.

In the structure shown in FIG. 4, the first holding capacitance portion C1 is configured to be divided into three holding capacitance portions C11, C12 and C13. That is, the three holding capacitance portions C11, C12 and C13 are electrically connected in parallel to thereby configure the first holding capacitance portion C1.

The second wiring layer L2 includes a first wiring portion L21 and a second wiring portion L22. The first wiring portion L21 and the second wiring portion L22 are electrically isolated from each other.

The first wiring portion L21 of the second wiring layer L2 composes one electrode of the holding capacitance portions C11 and C12. The first wiring portion L21 of the second wiring layer L2 is bonded to the second wiring portion L12 of the first wiring layer L1 through a through hole T21.

The second wiring portion L22 of the second wiring layer L2 composes a wiring portion connected to a first electrode portion that composes one electrode of the second holding capacitance portion C2. The second wiring portion L22 of the second wiring layer L2 is bonded to the third wiring portion L13 of the first wiring layer L1 through a through hole T22.

The second wiring layer L2 includes a first shield portion S1. The first shield portion S1 is composed of two first shield portions S21 and S22. The first shield portion S21 is electrically isolated from the first wiring portion L21 and the second wiring portion L22, which are formed on the same second wiring layer L2.

The first shield portion S21 is formed between the first wiring portion L21 of the second wiring layer L2 and the second wiring portion L22 of the second wiring layer L2 of the pixel circuit 11b adjacent to the pixel circuit 11a. The first shield portion S22 is formed between the first wiring portion L21 of the second wiring layer L2 and the second wiring portion L22 of the second wiring layer L2 of the pixel circuit 11a. The first shield portion S1 is formed of a similar wiring layer to the first wiring portion L21 and second wiring portion L22 of the second wiring layer L2. The first shield portion S1 is supplied with a shield potential. The shield potential is a predetermined fixed potential that is preset. The predetermined fixed potential is, for example, a higher power supply potential, a lower power supply potential such as a ground potential, an arbitrary intermediate potential set between the higher power supply potential and the lower power supply potential, or the like.

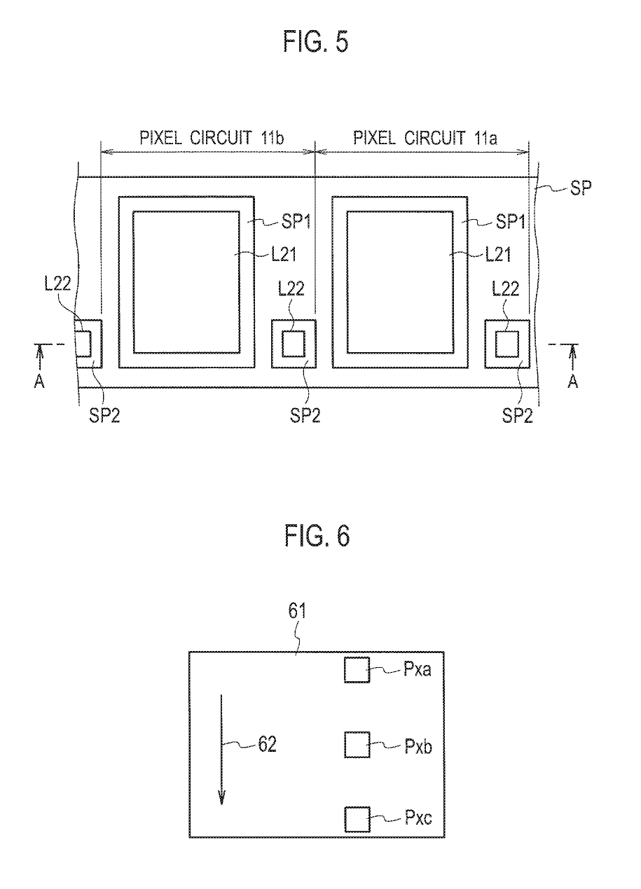

FIG. 5 is a view showing a planar structure of the second wiring layer L2. A cross section that goes along A-A of FIG. 5 is a cross section of the second wiring layer L2 of FIG. 4. As shown in FIG. 5, in the second wiring layer L2, a part of a shield pattern SP that composes each of the first shield portions S1, the shield pattern SP being formed on an entire surface of the second wiring layer L2, is selectively removed in an island shape. The first wiring portion L21 is formed in the inside of the removed spot SP1, and the second wiring portion L22 is formed in the inside of the removed spot SP2.

Returning back to FIG. 4, a first metal layer M1 is formed between the second wiring layer L2 and the third wiring layer L3. The first metal layer M1 is formed opposite to the first wiring portion L21 of the second wiring layer L2 so as to be spaced apart by a predetermined interval. The interlayer insulating film 410 is sandwiched between the first metal layer M1 and the first wiring portion L21 of the second wiring layer L2.

The first metal layer M1 is composed of metal, for example, such as titanium nitride (TiN) or titanium (Ti). The first metal layer M1 is composed of a first electrode portion M11 and a second electrode portion M12. The first electrode portion M11 and the second electrode portion M12 are electrically isolated from each other.

The first electrode portion M11 composes the other electrode of the holding capacitance portion C11. Hence, the holding capacitance portion C11 is formed of the MIM structure in which the interlayer insulating film 410 that becomes a dielectric is sandwiched between the first wiring portion L21 of the second wiring layer L2 and the first electrode portion M11 of the first metal layer M1.

The second electrode portion M12 composes the other electrode of the holding capacitance portion C12. Hence, the holding capacitance portion C12 is formed of the MIM structure in which the interlayer insulating film 410 that becomes a dielectric is sandwiched between the first wiring portion L21 of the second wiring layer L2 and the second electrode portion M12 of the first metal layer M1.

Above the first metal layer M1, the third wiring layer L3 is formed. The third wiring layer L3 includes a first wiring portion L31, a second wiring portion L32, a third wiring portion L33 and a fourth wiring portion L34. The first wiring portion L31, the second wiring portion L32, the third wiring portion L33 and the fourth wiring portion L34 are electrically isolated from one another.

The first wiring portion L31 of the third wiring layer L3 is connected to the reference potential common terminal Com shown in FIG. 1, and for example, is given the ground potential as the reference potential Vcom. The first wiring portion L31 of the third wiring layer L3 is bonded to the first electrode portion M11 of the first metal layer M1 through a through hole T31. The second wiring portion L32 of the third wiring layer L3 is bonded to the first wiring portion L21 of the second wiring layer L2 through a through hole T32.

The third wiring portion L33 of the third wiring layer L3 is connected to the reference potential common terminal Com shown in FIG. 1, and for example, is given the ground potential as the reference potential Vcom. The third wiring portion L33 of the third wiring layer L3 is bonded to the second electrode portion M12 of the first metal layer M1 through a through hole T33. The fourth wiring portion L34 of the third wiring layer L3 is bonded to the second wiring portion L22 of the second wiring layer L2 through a through hole T34.

A second metal layer M2 is formed between the third wiring layer L3 and the fourth wiring layer L4. The second metal layer M2 is composed of metal, for example, such as titanium nitride or titanium. The second metal layer M2 is composed of a first electrode portion M21 and a second electrode portion M22. The first electrode portion M21 and the second electrode portion M22 are electrically isolated from each other.

The first electrode portion M21 of the second metal layer M2 is formed opposite to the first wiring portion L31 of the third wiring layer L3 so as to be spaced apart by a predetermined interval. The interlayer insulating film 410 is formed between the first electrode portion M21 of the second metal layer M2 and the first wiring portion L31 of the third wiring layer L3.

The first electrode portion M21 of the second metal layer M2 composes the other electrode of the holding capacitance portion C13. Hence, the holding capacitance portion C13 is composed of the MIM structure in which the interlayer insulating film 410 that becomes a dielectric is sandwiched between the first wiring portion L31 of the third wiring layer L3 and the first electrode portion M21.

The second electrode portion M22 of the second metal layer M2 is formed opposite to the third wiring portion L33 of the third wiring layer L3 so as to be spaced apart by a predetermined interval. The interlayer insulating film 410 is formed between the second electrode portion M22 of the second metal layer M2 and the third wiring portion L33 of the third wiring layer L3.

The second electrode portion M22 of the second metal layer M2 composes the other electrode of the second holding capacitance portion C2. Hence, the second holding capacitance portion C2 is formed of the MIM structure in which the interlayer insulating film 410 that becomes a dielectric is sandwiched between the third wiring portion L33 of the third wiring layer L3 and the second electrode portion M22 of the second metal layer M2.

Above the second metal layer M2, the fourth wiring layer L4 is formed. The fourth wiring layer L4 includes a first wiring portion L41 and a second wiring portion L42. The first wiring portion L41 and the second wiring portion L42 are electrically isolated from each other.

The first wiring portion L41 of the fourth wiring layer L4 composes a wiring layer connected to the first electrode portion that composes one electrode of the first holding capacitance portion C1. The first wiring portion L41 of the fourth wiring layer L4 is bonded to the first electrode portion M21 of the second metal layer M2 through a through hole T41. The first wiring portion L41 of the fourth wiring layer L4 is bonded to the second wiring portion L32 of the third wiring layer L3 through a through hole T42.

The second wiring portion L42 of the fourth wiring layer L4 composes a wiring layer connected to the first electrode portion that composes one electrode of the second holding capacitance portion C2. The second wiring portion L42 of the fourth wiring layer L4 is bonded to the second electrode portion M22 of the second metal layer M2 through a through hole T43. The second wiring portion L42 of the fourth wiring layer L4 is bonded to the fourth wiring portion L34 of the third wiring layer L3 through a through hole T44.

The fourth wiring layer L4 includes a second shield portion S2. The second shield portion S2 is composed of two second shield portions S41 and S42. The second shield portion S2 is electrically isolated from the first wiring portion L41 and the second wiring portion L42, which are formed on the same fourth wiring layer L4.

The second shield portion S41 is formed between the first wiring portion L41 of the fourth wiring layer L4 and the second wiring portion L42 of the fourth wiring layer L4 of the pixel circuit 11b adjacent to the pixel circuit 11a. The second shield portion S42 is formed between the first wiring portion L41 of the fourth wiring layer L4 and the second wiring portion L42 of the fourth wiring layer L4 of the pixel circuit 11a. The second shield portion S2 is formed of a similar wiring layer to the first wiring portion L41 and second wiring portion L42 of the fourth wiring layer L4. The second shield portion S2 is supplied with the same shield potential as that supplied to the first shield portion S1.

In the above-described laminated structure, the first wiring portion L21 of the second wiring layer L2, which composes one electrode of the holding capacitance portion C11 and the holding capacitance portion C12, and the first electrode portion M21 of the second metal layer M2, which composes the one electrode of the holding capacitance portion C13, are electrically connected to each other.

Moreover, the first electrode portion M11 of the first metal layer M1, which becomes the other electrode of the holding capacitance portion C11, and the first wiring portion L31 of the third wiring layer L3, which becomes the other electrode of the holding capacitance portion C13, are electrically connected to each other, and are given the ground potential. Furthermore, the second electrode portion M12 of the first metal layer M1, which becomes the other electrode of the holding capacitance portion C12, and the third wiring portion L33 of the third wiring layer L3 are electrically connected to each other, and are given the ground potential.

In such a way, the capacitance C11, the holding capacitance portion C12 and the holding capacitance portion C13 are connected in parallel to one another. The electrodes of the holding capacitance portion C11, the holding capacitance portion C12 and the holding capacitance portion C13, which are not given the ground potential and are connected parallel to one another, are electrically connected to the diffusion layer 403, which becomes the source region of the first transistor Tr1 and the drain region of the second transistor Tr2.

Hence, the electrodes of the holding capacitance portion C11, the holding capacitance portion C12 and the holding capacitance portion C13, which are connected to one another in parallel, compose the first electrode portion 14a of the first holding capacitance portion C1.

The respective other electrodes of the holding capacitance portion C11, the holding capacitance portion C12 and the holding capacitance portion C13 are commonly given the ground potential. That is, the respective electrodes of the holding capacitance portion C11, the holding capacitance portion C12 and the holding capacitance portion C13, which are given the ground potential, compose the second electrode portion 14b of the first holding capacitance portion C1.

In the above-described laminated structure, the second electrode portion M22 of the second metal layer M2, which becomes one electrode of the second holding capacitance portion C2, is electrically connected to the diffusion layer 406 that becomes the source region of the second transistor Tr2. The third wiring portion L33 of the third wiring layer L3, which becomes the other electrode of the second holding capacitance portion C2, is given the ground potential.

In such a way, the second electrode portion M22 of the second metal layer M2, which becomes one electrode of the second holding capacitance portion C2, composes the first electrode portion 15a of the second holding capacitance portion C2, which is shown in FIG. 1. The third wiring portion L33 of the third wiring layer L3, which becomes the other electrode of the second holding capacitance portion C2, composes the second electrode portion 15b of the second holding capacitance portion C2, which is shown in FIG. 1.

In the holding capacitance portion C11, the holding capacitance portion C12 and the holding capacitance portion C13, which compose the first holding capacitance portion C1, and the second holding capacitance portion C2, the dielectrics, each of which are sandwiched between both of the electrodes, and distances between both of the electrodes are set equal to one another.

Hence, a capacitance value of each of the holding capacitance portion C11, the holding capacitance portion C12 and the holding capacitance portion C13, which compose the first holding capacitance portion C1, and the second holding capacitance portion C2 is determined by an area of the electrodes of each of the holding capacitance portions.

Above the fourth wiring layer L4, the pixel electrode 16a is formed through the interlayer insulating film 410. The pixel electrode 16a is bonded to the second wiring portion L42 of the fourth wiring layer L4 through a through hole T51.

In such a way, the pixel electrode 16a is electrically connected to the diffusion layer 406, which forms the source region of the second transistor Tr2, through the first wiring layer L1 to the fourth wiring layer L4 and the through holes which bond these to one another.

Above the pixel electrode 16a, the liquid crystal LC is formed so as to be sandwiched between orientation layers 411a and 411b, which orient initial molecular arrangement of the liquid crystal LC in a predetermined direction.

Above the liquid crystal LC, the common electrode 16b is formed. In such a way, the liquid crystal LC is formed by being filled and sealed between the pixel electrode 16a and the common electrode 16b.

Above the common electrode 16b, a transparent substrate 412 is formed. In such a way, the pixel circuit 11 is formed so as to be sandwiched between the semiconductor substrate 400 and the transparent substrate 412.

The incident light, which is made incident from the transparent substrate 412, passes through the liquid crystal LC, and reaches the pixel electrode 16a, and the incident light, which has reached the pixel electrode 16a, is reflected on the pixel electrode 16a, passes through the liquid crystal LC one more time and is emitted from the transparent substrate 412. In this process, the incident light is modulated in the liquid crystal LC in response to the voltage of the pixel signal, which is applied to the pixel electrode 16a, and display corresponding to the pixel signal is performed.

Next, the first embodiment and the prior art that does not adopt the configuration of the first shield portion S1 and the second shield portion S2, which is the technical feature of the first embodiment, are compared with each other, whereby a description is made of effects obtained in the first embodiment.

First, a description is made of a defect brought about by the prior art.

Here, on a liquid crystal display screen 61 of the liquid crystal display device 1, which is shown in FIG. 6, among the respective pixels composed of the plurality of pixel circuits 11 arranged in a matrix fashion, a pixel Pxa is taken as a representative of pixels located on a starting point side of the scanning with respect to the vertical scanning direction shown by an arrow 62 of FIG. 6. A pixel Pxb is taken as a representative of pixels located on a substantially intermediate side of the scanning with respect to the vertical scanning direction 62. A pixel Pxc is taken as a representative of pixels located on an ending point side of the scanning with respect to the vertical scanning direction 62.

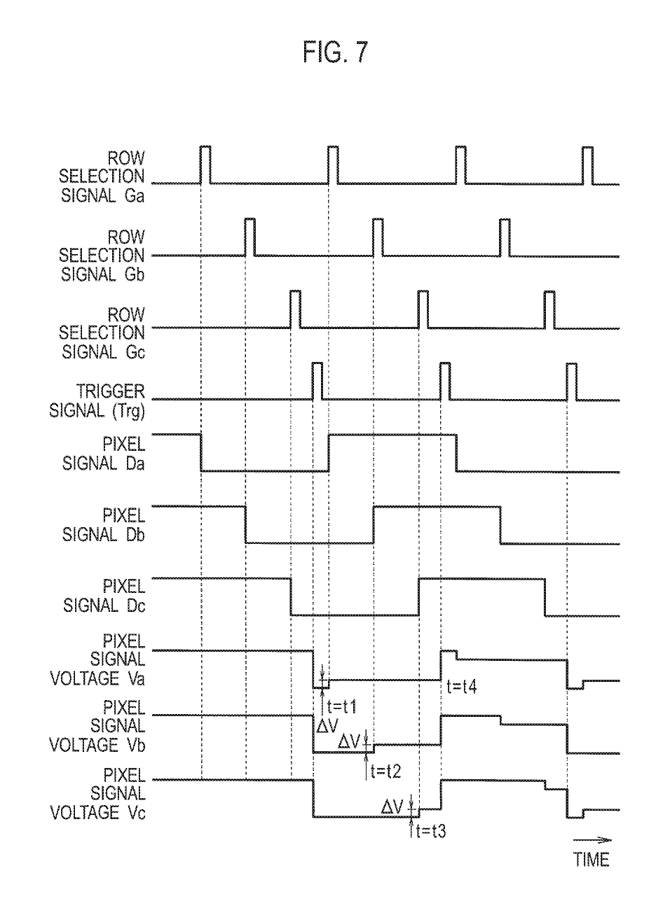

FIG. 7 is a timing chart showing schematic signal waveforms of a variety of signals related to the pixel Pxa, the pixel Pxb and the pixel Pxc. Note that, in the timing chart shown in FIG. 7, the variety of signals indicate voltage changes in an event where the white color is displayed on the respective pixels Pxa, Pxb and Pxc. Moreover, in the timing chart shown in FIG. 7, the variety of signals indicate voltage changes in an event where the liquid crystal LC is driven by an alternating current in such a manner that the polarities of the voltages applied to both of the electrodes of the liquid crystal LC are alternately inverted every frame period.

In FIG. 7, the respective pixel circuits 11 which compose the respective pixels Pxa, Pxb and Pxc are sequentially supplied with the row selection signals during one vertical scanning period, and are supplied with the pixel signals in synchronization with the row selection signals.

That is, in the pixel circuit 11 of the pixel Pxa, at a time t1, a row selection signal Ga is supplied to the gate terminal of the first transistor Tr1, and a high-level pixel signal Da is supplied thereto. In such a way, into the pixel circuit 11 of the pixel Pxa, the pixel signal Da is written through the first transistor Tr1 at the time t1. A pixel signal voltage of the written pixel signal Da is held in the first electrode portion 14a of the first holding capacitance portion C1.

In the pixel circuit 11 of the pixel Pxb, at a time t2, a row selection signal Gb is supplied to the gate terminal of the first transistor Tr1, and a high-level pixel signal Db is supplied thereto. In such a way, into the pixel circuit 11 of the pixel Pxb, the pixel signal Db is written through the first transistor Tr1 at the time t2. A pixel signal voltage of the written pixel signal Db is held in the first electrode portion 14a of the first holding capacitance portion C1.

In the pixel circuit 11 of the pixel Pxc, at a time t3, a row selection signal Gc is supplied to the gate terminal of the first transistor Tr1, and a high-level pixel signal Dc is supplied thereto. In such a way, the pixel signal Dc is written into the pixel circuit 11 of the pixel Pxc through the first transistor Tr1 at the time t3. A pixel signal voltage of the written pixel signal Dc is held in the first electrode portion 14a of the first holding capacitance portion C1.

Thereafter, when a trigger signal (Trg) is simultaneously supplied to the pixel circuits 11 of the respective pixels Pxa, Pxb and Pxc at a time t4, the respective pixel signals Da, Db and Dc are transferred to and held in the first electrode portion 15a of the second holding capacitance portion C2. In such a way, the pixel signals of the respective pixel circuits 11 of the respective pixels Pxa, Pxb and Pxc are updated. That is, low-level pixel signals of the respective pixel circuits 11 of the respective pixels Pxa, Pxb and Pxc are updated to high-level pixel signals.

Here, a case is assumed where a parasitic capacitance is formed between the first electrode portion 14a of the first holding capacitance portion C1 and the first electrode portion 15a of the second holding capacitance portion C2.

When the parasitic capacitance is formed, the first electrode portion 14a of the first holding capacitance portion C1 and the first electrode portion 15a of the second holding capacitance portion C2 are subjected to parasitic capacitance coupling.

In such a way, when the pixel signal is written into the first electrode portion 14a of the first holding capacitance portion C1, the voltage change of the first electrode portion 14a of the first holding capacitance portion C1 causes a crosstalk to the first electrode portion 15a of the second holding capacitance portion C2. When the crosstalk of the voltage occurs, there changes the pixel signal voltage of the pixel signal held in the first electrode portion 15a of the second holding capacitance portion C2 until then.

A period while the change of the pixel signal voltage is occurring differs depending on timing of writing the pixel signal into the pixel circuit 11.

In the timing chart of FIG. 7, when the pixel signal Da is written into the pixel circuit 11 of the pixel Pxa, at the time t1, then by the above-described parasitic capacitance, the low-level pixel signal voltage Va held until then changes to rise by a predetermined voltage ΔV.

Thereafter, when the trigger signal (Trg) is supplied at the time t4, the pixel signal voltage Va becomes the high-level pixel signal voltage of the pixel signal written into the pixel circuit 11 of the pixel Pxa. Hence, in the pixel circuit 11 of the pixel Pxa, the pixel signal voltage Va held during a period from the time t1 to the time t4 changes.

When the pixel signal Db is written into the pixel circuit 11 of the pixel Pxb, at the time t2, then by the above-described parasitic capacitance, the low-level pixel signal voltage Vb held until then changes to rise by the predetermined voltage ΔV.

Thereafter, when the trigger signal (Trg) is supplied at the time t4, the pixel signal voltage Vb becomes the high-level pixel signal voltage of the pixel signal written into the pixel circuit 11 of the pixel Pxb. Hence, in the pixel circuit 11 of the pixel Pxb, the pixel signal voltage Vb held during a period from the time t2 to the time t4 changes.

In the pixel circuit 11 of the pixel Pxc, when the pixel signal Dc is written at the time t3, then by the above-described parasitic capacitance, the low-level pixel signal voltage Vc held until then changes to rise by the predetermined voltage ΔV.

Thereafter, when the trigger signal (Trg) is supplied at the time t4, the pixel signal voltage Vc becomes the high-level pixel signal voltage of the pixel signal written into the pixel circuit 11 of the pixel Pxc. Hence, in the pixel circuit 11 of the pixel Pxc, the pixel signal voltage Vc held during a period from the time t3 to the time t4 changes.

As described above, the period while the change of the pixel signal voltage is occurring is longest in the pixel circuit 11 of the pixel Pxa, and subsequently, is shorter in the pixel circuit 11 of the pixel Pxb and the pixel circuit 11 of the pixel Pxc in that order.

When the period while the change of the pixel signal voltage of the pixel signal is occurring differs among the respective pixels Pxa, Pxb and Pxc during one vertical scanning period, a period while brightness of each of the pixels Pxa, Pxb and Pxc is changing also differs among the respective pixels Pxa, Pxb and Pxc. That is, the period while the brightness of each of the pixels Pxa, Pxb and Pxc is being lowered is longest in the pixel Pxa, and subsequently, is shorter in the pixel Pxb and the pixel Pxc in that order.

In such a way, the closer to the top of the liquid crystal display screen 61, the longer the period where the brightness of the display image is lowered, and the closer to the bottom of the liquid crystal display screen 61, the shorter the period where the brightness of the display image is lowered. As a result, the difference of the period where the brightness of the display image is lowered in the vertical direction causes a defect in that the contrast in the upper portion of the liquid crystal display screen 61 is lowest and the contrast in the lowest portion of the liquid crystal display screen 61 is highest. That is, the contrast is not consistent within the whole liquid crystal display screen 61 in the vertical direction, and it decreases the higher up vertically on the liquid crystal display screen 61 it is.

In contrast, the liquid crystal display device 1 according to the first embodiment includes the first shield portion S1 (S21 and S22) and the second shield portion S2 (S41 and S42).

The first shield portions S21 and S22 are supplied with the predetermined fixed potential, and thereby shield the first wiring portion L21 of the second wiring layer L2 and the second wiring portion L22 of the second wiring layer L2 from each other. That is, the first shield portions S21 and S22 shield the first electrode portion that composes one electrode of the first holding capacitance portion C1 and the wiring portion connected to the first electrode portion that composes one electrode of the second holding capacitance portion C2 from each other.

In such a way, the first shield portions S21 and S22 absorb an influence of an electric field between the first electrode portion that composes one electrode of the first holding capacitance portion C1 and the wiring portion connected to the first electrode portion that composes one electrode of the second holding capacitance portion C2.

Meanwhile, the second shield portions S41 and S42 are supplied with the predetermined fixed potential, and thereby shield the first wiring portion L41 of the fourth wiring layer L4 and the second wiring portion L42 of the fourth wiring layer L4 from each other. That is, the above-described second shield portions S41 and S42 shield the wiring portion connected to the first electrode portion that composes one electrode of the first holding capacitance portion C1 and the wiring portion connected to the first electrode portion that composes one electrode of the second holding capacitance portion C2 from each other.

In such a way, the second shield portions S41 and S42 absorb an influence of an electric field between the wiring portion connected to the first electrode portion that composes the one electrode of the first holding capacitance portion C1 and the wiring portion connected to the first electrode portion that composes the one electrode of the second holding capacitance portion C2.

When the influence of the electric field is absorbed, the capacitance value of the parasitic capacitance formed between the first electrode portion 14a that becomes the one electrode of the holding capacitance portion C1 and the first electrode portion 15a that becomes one electrode of the second holding capacitance portion C2 is reduced.

In such a way, the parasitic capacitance coupling between one electrode of the first holding capacitance portion C1 and one electrode of the second holding capacitance portion C2 is reduced. As a result, the voltage crosstalk between one electrode of the first holding capacitance portion C1 and one electrode of the second holding capacitance portion C2 is reduced.

When the voltage crosstalk between both of the electrodes is decreased, the above-mentioned variation of the pixel signal voltage of the pixel signal, which is caused by the voltage crosstalk, is suppressed. In such a way, the brightness variation among the respective pixels which compose the liquid crystal display screen is reduced, and the brightness difference is suppressed between a display image on the upper portion of the liquid crystal display screen and a display image on the lower portion is suppressed. As a result, the contrast of the display image in the vertical direction is prevented from varying, and the contrast of the display image can be made uniform to a greater extent.

### Second Embodiment

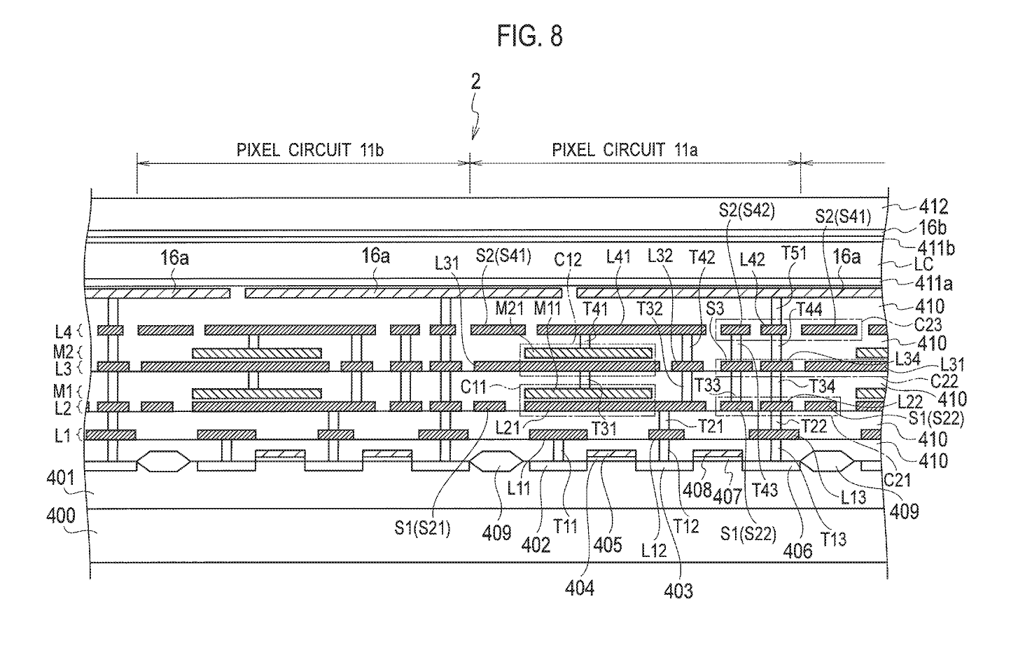

FIG. 8 is a cross-sectional view showing a schematic cross-sectional structure of a pixel circuit in a liquid crystal display device according to a second embodiment of the present invention.

In a liquid crystal display device 2 shown in FIG. 8, a circuit configuration and operations thereof are similar to those of the liquid crystal display device 1 of the first embodiment, and accordingly, a description is omitted.

A difference between the liquid crystal display device 1 of the first embodiment and the liquid crystal display device 2 of the second embodiment is that a second holding capacitance portion C2 of the second embodiment does not adopt the MIM structure while the second holding capacitance portion C2 of the first embodiment does. That is, the second holding capacitance portion C2 of the second embodiment is composed of a capacitance formed between first to third shield portions to be described later and wiring portions on peripheries of the first to third shield portions.

Mainly with regard to the difference from that of the first embodiment, referring to FIG. 8, a description is made of a cross-sectional structure of the pixel circuit of the liquid crystal display device 2 of the second embodiment. Note that, in the liquid crystal display device 2 shown in FIG. 8, those denoted by the same reference numerals as those of the liquid crystal display device 1 of the first embodiment, which is shown in FIG. 4, have similar functions.

FIG. 8 illustrates a cross-sectional structure of two pixel circuits 11a and 11b in a transverse direction of a sheet surface, and all of the pixel circuits have a similar structure, and accordingly, the pixel circuit 11a shown in FIG. 8 is taken as a representative, and the structure of the pixel circuit 11 is described.

As will be described below, a large number of the pixel circuits 11 are arranged in a matrix fashion on a semiconductor substrate, and accordingly, as a pixel circuit adjacent to the pixel circuit 11a, the pixel circuit 11b shown in FIG. 8 is referred to while being taken as a representative.

In FIG. 8, a first transistor Tr1 and a second transistor Tr2 are formed on a semiconductor substrate 400 made of a silicon substrate in a similar way to the first embodiment.

A multilayer wiring structure is formed in the region above the region where the first transistor Tr1 and the second transistor Tr2 are formed. By this multilayer wiring structure, the first holding capacitance portion C1 and second holding capacitance portion C2 of one pixel circuit 11 are formed.

In the multilayer wiring structure shown in FIG. 8, the first holding capacitance portion C1 is configured to be divided into two holding capacitance portions C11 and C12. That is, the two holding capacitance portions C11 and C12 are connected electrically in parallel to thereby configure the first holding capacitance portion C1. Hence, in comparison with the first holding capacitance portion C1 of the first embodiment, the first holding capacitance portion C1 of the second embodiment is configured in such a manner that the holding capacitance portion C13 is not present.

In this multilayer wiring structure, a first wiring layer L1, a second wiring layer L2, a third wiring layer L3 and a fourth wiring layer L4 are formed in order from the semiconductor substrate 400 toward an upper side. The first wiring layer L1 and the second wiring layer L2 are configured in a similar way to the first embodiment.

A first electrode portion M11 of a first metal layer M1, which is similar to that of the first embodiment, is formed between the second wiring layer L2 and the third wiring layer L3. In the second embodiment, the second electrode portion M12 of the first metal layer M1 of the first embodiment is not present.

The first electrode portion M11 composes the other electrode of the holding capacitance portion C11. Hence, the holding capacitance portion C11 is formed of the MIM structure in which the interlayer insulating film 410 that becomes a dielectric is sandwiched between the first wiring portion L21 of the second wiring layer L2 and the first electrode portion M11 of the first metal layer M1.

Above the first metal layer M1, the third wiring layer L3 is formed. The third wiring layer L3 includes a first wiring portion L31, a second wiring portion L32, a fourth wiring portion L34, and a third shield portion S3. The first wiring portion L31, the second wiring portion L32 and the fourth wiring portion L34 are configured in a similar way to the first embodiment. In the second embodiment, the third wiring layer L3 includes the third shield portion S3 in place of the third wiring portion L33 of the first embodiment.

The third shield portion S3 is formed between the second wiring portion L32 of the third wiring layer L3 and the fourth wiring portion L34 of the third wiring layer L3. The third shield portion S3 is formed of a similar wiring layer to the first wiring portion L31, second wiring portion L32 and fourth wiring portion L34 of the third wiring layer L3. The third shield portion S3 is commonly supplied with the same shield potential as that supplied to the first shield portion S1. The third shield portion S3 is connected to the first shield portion S21 through the through hole T33.

The third shield portion S3 shields the second wiring portion L32 of the third wiring layer L3, which becomes the wiring portion connected to one electrode of the first holding capacitance portion C1, and the fourth wiring portion L34 of the third wiring layer L3, which becomes one electrode of the second holding capacitance portion C2, from each other.

A first electrode portion M21 of a second metal layer M2, which is similar to that of the first embodiment, is formed between the third wiring layer L3 and the fourth wiring layer L4. In the second embodiment, the second electrode portion M22 of the second metal layer M2 of the first embodiment is not present.

The first electrode portion M21 composes the other electrode of the holding capacitance portion C12. Hence, the holding capacitance portion C12 is formed of the MIM structure in which the interlayer insulating film 410 that becomes a dielectric is sandwiched between the first wiring portion L31 of the third wiring layer L3 and the first electrode portion M21 of the second metal layer M2.

Above the second metal layer M2, the fourth wiring layer L4 is formed. The fourth wiring layer L4 is configured in a similar way to the first embodiment. The second shield portion S42 of the fourth wiring layer L4 is connected to the third shield portion S3 through the through hole T43.

In the above-described laminated structure, above the diffusion layer 406 that becomes the source region of the second transistor Tr2, a stacked via structure formed by stacking the through holes T22, T34, T44 and T51 on top of one another is formed. The second holding capacitance portion C2 is composed of a capacitance formed between the wiring portions connected to one another by the through holes T34 and T44 of this stacked via structure and wiring portions on the peripheries.

That is, the second holding capacitance portion C2 is composed of the following capacitances C21, C22 and C23 connected parallel to one another.

The capacitance C21 is a capacitance formed between the second wiring portion L22 of the second wiring layer L2 and the first shield portion S1. The capacitance C22 is a capacitance formed between the fourth wiring portion L34 of the third wiring layer L3 and the third shield portion S3, and is a capacitance formed between the fourth wiring portion L34 of the third wiring layer L3 and the first wiring portion L31 of the third wiring portion L33. The capacitance C23 is a capacitance formed between the second wiring portion L42 of the fourth wiring layer L4 and the second shield portion S2.

The second holding capacitance portion C2 is configured as mentioned above, whereby the liquid crystal display device 2 according to the second embodiment can obtain effects, which will be mentioned below, in addition to the effects obtained in the first embodiment.

The second holding capacitance portion C2 can simplify the wiring structure of the wires connected to the capacitances in comparison with the MIM structure adopted in the first embodiment.

Moreover, one electrode of the second holding capacitance portion C2 includes the first shield portion S1, the second shield portion S2 and the third shield portion S3, and accordingly, the second holding capacitance portion C2 can reduce the capacitance coupling with the wiring portions on the peripheries of the second holding capacitance portion C2. Furthermore, from a viewpoint of enhancing transfer efficiency of the pixel signal voltage of the pixel signal, it is required to reduce the capacitance value of the second holding capacitance portion C2 in comparison with the capacitance value of the first holding capacitance portion C1. The second holding capacitance portion C2 can easily satisfy such a requirement by adopting the above-described structure.

In the reflection-type liquid crystal display device, when the incident light made incident onto the pixel circuit 11 reaches the first transistor Tr1 and the second transistor Tr2, it is possible that light leak currents may be generated in the first transistor Tr1 and the second transistor Tr2. From a viewpoint of suppressing the light leak currents, in general, the reflection-type liquid crystal display device adopts a light shielding structure of reducing the incident light, which reaches the transistors, by reducing gaps among the wires in the multilayer wiring structure.

In the reflection-type liquid crystal display device, the above-mentioned light shielding structure is typically adopted unless the above-mentioned problem inherent in the conventional liquid crystal display device exists. In a case of the structure shown in FIG. 4, a structure is typically adopted in which the second shield portion S41 and the first wiring portion L41 of the fourth wiring layer L4 are formed into the same continuous wiring portion, for example, in place of the second shield portion S41. Moreover, in general, a structure is adopted, in which the second shield portion S42 and the second wiring portion L42 of the fourth wiring layer L4 are formed into the same continuous wiring portion, for example, in place of the second shield portion S42.

By adopting these structures, the gaps among the wires are reduced, an advantage is brought from a viewpoint of light shielding properties, and the optical leak currents are suppressed.

In contrast, in order to solve the above-described problem, the first and second embodiments adopt the structure, which includes the first shield portion S1 and the second shield portion S2, in place of adopting the above-described light shielding structure.

The liquid crystal display device, in which the pixel circuit 11 includes two transistors, is required to enhance voltage transfer efficiency of transferring the pixel signal voltage of the pixel signal, which is held in the first holding capacitance portion C1, to the second holding capacitance portion C2. In order to satisfy this requirement, it is preferable that the capacitance value of the first holding capacitance portion C1 be larger than the capacitance value of the second holding capacitance portion C2.

A structure of increasing the capacitance value of the first holding capacitance portion C1 is typically adopted unless the above-mentioned problem inherent in the conventional liquid crystal display device exists. In a case of the structure shown in FIG. 4, it is usual to adopt a structure of expanding the electrode area of the first holding capacitance portion C1 by extending the first wiring portion L21 of the second wiring layer L2 in the right and left direction, for example, in place of the first shield portion S1.

By adopting these structures, the capacitance value of the first holding capacitance portion C1 is increased, and an advantage is brought from a viewpoint of enhancing the above-described voltage transfer efficiency.

In contrast, in order to solve the above-described problem, the first and second embodiments adopt the structure, which includes the first shield portion S1 and the second shield portion S2, in place of adopting the structure of enhancing the voltage transfer efficiency.

What is claimed is:

1. A liquid crystal display device comprising:
a plurality of pixel circuits sandwiched between a semiconductor substrate and a transparent substrate and arranged in a matrix fashion,
wherein the pixel circuits include:
pixel portions, each having a liquid crystal sandwiched between a pixel electrode formed on the semiconductor substrate and a common electrode formed on the transparent substrate, in which the liquid crystal is driven in response to a potential difference between a voltage applied to the pixel electrode and a voltage applied to the common electrode, and incident light from the transparent substrate is modulated in the liquid crystal in response to the potential difference;
drive portions, each having: a first transistor that is formed on the semiconductor substrate and selectively receives a pixel signal; a first holding capacitance portion that holds the pixel signal selectively received through the first transistor; a second transistor that is formed on the semiconductor substrate and transfers the pixel signal held in the first holding capacitance portion; and a second holding capacitance portion that holds the pixel signal transferred through the second transistor, the drive portions collectively transferring the pixel signals, which are held in all of the first holding capacitance portions of the plurality of pixel circuits, to all of the second holding capacitance portions of the plurality of pixel circuits, and driving the liquid crystals by applying, to the pixel electrodes, voltages corresponding to the pixel signals held in the second holding capacitance portions; and
shield portions, each being disposed between a first electrode portion that composes one electrode of the first holding capacitance portion or a first wiring portion connected to the first electrode portion and a second electrode portion that composes one electrode of the second holding capacitance portion or a second wiring portion connected to the second electrode portion,
wherein each of the shield portions is supplied with a predetermined shield potential that is preset.

2. A liquid crystal display device comprising:
a plurality of pixel circuits sandwiched between a semiconductor substrate and a transparent substrate and arranged in a matrix fashion,
wherein the pixel circuits include:
pixel portions, each having a liquid crystal sandwiched between a pixel electrode formed on the semiconductor substrate and a common electrode formed on the transparent substrate, in which the liquid crystal is driven in response to a potential difference between a voltage applied to the pixel electrode and a voltage applied to the common electrode, and incident light from the transparent substrate is modulated in the liquid crystal in response to the potential difference;
drive portions, each having: a first transistor that is formed on the semiconductor substrate and selectively receives a pixel signal; a first holding capacitance portion that holds the pixel signal selectively received through the first transistor; a second transistor that is formed on the semiconductor substrate and transfers the pixel signal held in the first holding capacitance portion; and a second holding capacitance portion that holds the pixel signal transferred through the second transistor, the drive portions collectively transferring the pixel signals, which are held in all of the first holding capacitance portions of the plurality of pixel circuits, to all of the second holding capacitance portions of the plurality of pixel circuits, and driving the liquid crystals by applying, to the pixel electrodes, voltages corresponding to the pixel signals held in the second holding capacitance portions; and
shield portions, each being disposed between a first electrode portion that composes one electrode of the first holding capacitance portion or a first wiring portion connected to the first electrode portion and a second electrode portion that composes one electrode of the second holding capacitance portion,
wherein each of the shield portions is supplied with a predetermined shield potential that is preset.

3. The liquid crystal display device according to claim 2, wherein each of the second holding capacitance portions is configured in a manner where the shield portion is used as the other electrode, and the second electrode portion is disposed on a periphery of the shield portion while being insulated from the shield portion.

4. The liquid crystal display device according to claim 1,
wherein each of the shield portions includes a first shield portion and a second shield portion,
the first shield portion is disposed between the first electrode portion and the second wiring portion, and
the second shield portion is disposed between the first wiring portion and the second wiring portion.

5. The liquid crystal display device according to claim 2,
wherein each of the shield portions includes a first shield portion, a second shield portion and a third shield portion,
the first shield portion is disposed between the first electrode portion and the second electrode portion,
the second shield portion is disposed between the first wiring portion and the second electrode portion, and
the third shield portion is disposed between the first wiring portion and the second electrode portion.

6. The liquid crystal display device according to claim 4,
wherein the first shield portion, the first electrode portion and the second wiring portion are disposed on a same wiring layer formed on the semiconductor substrate,
the second shield portion, the first electrode portion and the second wiring portion are disposed on a same wiring layer formed on the semiconductor substrate, and
the wiring layer in which the first shield portion is disposed and the wiring layer in which the second shield portion is disposed are different wiring layers.

7. The liquid crystal display device according to claim 5,
wherein the first shield portion, the first electrode portion, and the second electrode portion are disposed on a same wiring layer formed on the semiconductor substrate,
the second shield portion, the first wiring portion, and the second electrode portion are disposed on a same wiring layer formed on the semiconductor substrate,
the third shield portion, the first electrode portion, and the second wiring portion are disposed on a same wiring layer formed on the semiconductor substrate, and
the wiring layer in which the first shield portion is disposed, the wiring layer in which the second shield portion is disposed, and the wiring layer in which the third shield portion is disposed are different wiring layers.

8. The liquid crystal display device according to claim 1, wherein each of the first and second wiring portions is composed of a plurality of wiring layers formed by being stacked on the semiconductor substrate.

9. The liquid crystal display device according to claim 2, wherein each of the first wiring portions is composed of a plurality of wiring layers formed by being stacked on the semiconductor substrate.
